(19) United States
(12) Patent Application Publication
(10) Pub. No.: US 2015/0033138 A1
(43) Pub. Date: Jan. 29, 2015

(54) Phone Number Based Task Assignment, Task Tracking And Tasks Management System

(71) Applicant: Monica Manchanda, Delhi (IN)

(72) Inventor: Monica Manchanda, Delhi (IN)

(21) Appl. No.: 13/952,688

(22) Filed: Jul. 29, 2013

(51) Int. Cl. G06F 3/0484

(52) U.S. Cl. CPC G06F 3/0484
USPC 715/739

(57) ABSTRACT

A task supervising system for allowing registered users to assign a task to a phone number that is pre sent in contact list of their respective communication devices. Further, the task supervising system also allows its registered users to assign a supervisor for the task by typing a phone number. In addition, the task supervising system enables the users to view tasks related to their phone numbers. The users may manage their tasks, or track or update status/progress of their tasks. Furthermore, the task supervising system enables the users to add attributes and remarks to their tasks. Moreover, the task supervising system enables the users to send reminders to other users for completing tasks or for sharing status of the tasks. Additionally, the task supervising system enables the users to mark a task or a phone number as a junk-task or as a source of junk-tasks, respectively.

### FIELD OF THE INVENTION

Embodiments of present invention generally relate to task management. More specifically, the present invention relates to assigning, tracking, and managing of tasks.

### BACKGROUND OF THE INVENTION

Generally, everyone's life revolves around their daily tasks or targets being in personal or in official matters. Everyone needs to manage a number of tasks every day. Thereby, a lot of people delegate few or all of such tasks to other people. However, supervision for such delegated tasks is still required. Further, as the tasks are mostly delegated to other people by verbal communication or via Emails or SMSs, therefore, it is not possible for task delegators to track status of the delegated tasks without contacting responsible persons. Furthermore, only possible way to track status of the delegated tasks is by sending queries or reminders to concerned person via Emails, SMSs or telephone calls for updates. This requires extra time and efforts of the task delegators in supervising the delegated tasks.

Further, as a general scenario, everyone on daily basis receives a lot of emails in their email accounts, out of which only 10% emails requires actual attention or action. However, in order to track such 10% emails, concerned person needs to scan all of unread emails in their respective email accounts. This is time consuming process and may reduce interest of concerned person to scan all the unread emails, which results in unattended emails that may includes urgent tasks or information.

Therefore, there is requirement for a method and system that is capable of handling all aforementioned issues and provides a convenient and user friendly environment for task delegation and monitoring of the delegated tasks.

### SUMMARY

Embodiments of the present invention support use of a task supervising system that comprises a task assignment module configured to create and assign a task to a user of a communication device based on phone number of the user. The task supervising system further comprises a task viewing module configured to let a user view tasks that are related to the user based on his mobile number. Further, the task supervising system comprises of a task handling module configured to provide a user with a plurality of options to handle the tasks that are viewed with help of the task viewing module. Furthermore, the task supervising system comprises a status reporting module configured to inform all users those are related with the task corresponding to status of the task.

### BRIEF DESCRIPTION OF THE DRAWINGS

Having thus described the present invention in general terms, reference will now be made to the accompanying drawings, which are not necessarily drawn to scale, and wherein

FIG. 1 illustrates an exemplary environment where various embodiments of the present invention are implemented;

FIG. 2 illustrates a block diagram of a system for enabling registered users to manage their tasks by using a task managing application, in accordance with an embodiment of the present invention;

FIG. 3 illustrates another exemplary environment where various embodiments of the present invention are implemented; and

FIG. 4 illustrates a flow diagram of a method for creating, assigning and monitoring a task, in accordance with an embodiment of the present invention.

### DETAILED DESCRIPTION OF THE INVENTION

Illustrative embodiments of the present invention now will be described more fully hereinafter with reference to accompanying drawings, in which some, but not all embodiments of the present invention are shown. Indeed, the present invention may be embodied in many different forms and should not be construed as limited to the embodiments set forth herein; rather, these embodiments are provided so that this disclosure will satisfy applicable legal requirements. Like numbers refer to like elements throughout.

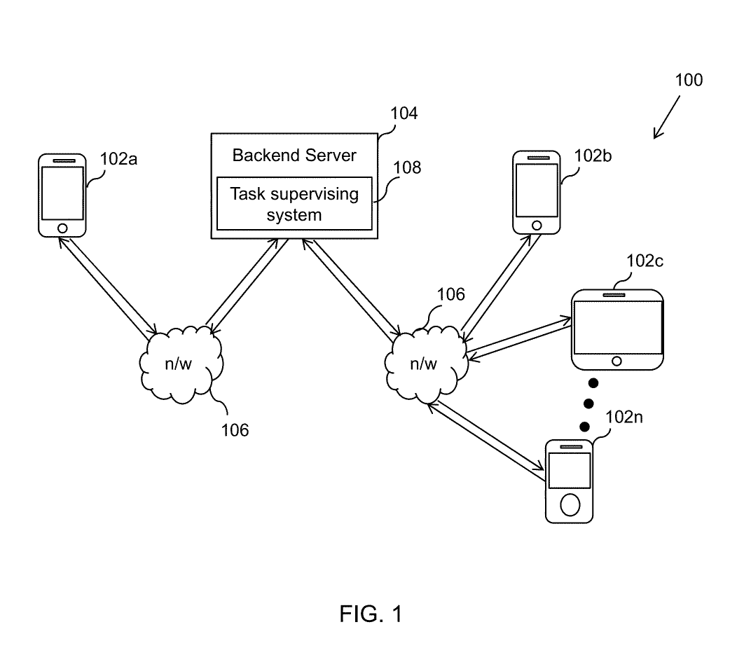

FIG. 1 illustrates an exemplary environment 100 where various embodiments of the present invention are implemented. The environment 100 includes a number of user devices, such as user devices 102a, 102b, 102c . . . 102n. The user devices may refer to any electronic device that may be utilized by their respective users to communicate with other users. Examples of the user devices may include, but are not restricted to, a tablet computer, a smart phone, a personal digital assistant, a cell phone, a landline phone, and like.

Further, as shown, the user device 102a is in communication with a backend server 104 via a network 106. The network 106 may include, but is not restricted to, a communication network such as Internet, Metropolitan Area Network (MAN), Local Area Network (LAN), Wide Area Network (WAN), PSTN, GSM, CDMA, and so forth. In an embodiment, the network 106 can be a data network such as Internet or Intranet. In another embodiment, the network 106 may facilitate the user devices to communicate with each other by using SMS or USSD protocols.

Furthermore, the backend server 104 includes a task supervising system 108. In an embodiment of the present invention, the task supervising system 108 is configured to create/schedule/allocate new tasks on requests of its registered users. In addition, the task supervising system 108 is configured to manage and track status of tasks that are already assigned to one or more registered users. Further, in an embodiment, the task supervising system 108 may also be configured to send notifications (via SMS or via mobile OS based notifications) to concerned registered users on completion of their related tasks. The task supervising system 108 is further configured to send notifications as sms or mobile OS based notifications in case of any delays or some duration prior to expected completion time of important tasks, in case same has been configured by creator or owner of task.

Additionally, as shown, the backend server 104 is connected to plurality of other user devices, such as user devices 102b, 102c . . . 102n, via the network 106. In an embodiment of the present invention, all of the user devices are connected to the backend server 104 in order to manage their task schedules. The task supervising system 108 of the backend server 104 enables the connected user devices to create new tasks, view existing tasks, assign tasks to other users, track status of the tasks assigned to other users, and manage tasks.

In an exemplary embodiment of the present invention, a user may register his/her communication device with the backend server 104 over the network 106. The registration process may involve validating phone number of a user. Validation process may include, but is not limited to, confirmation of phone number of the user via SMS, GPRS, USSD, IVR, or via any combination of these to ensure validity of the phone number of the user. After successful registration, the backend server 104 may allow the user to use a task managing software application (hereinafter may be referred to as “task managing application”) to create, track, and manage the tasks.

After registration, the user may connect to the task supervising system 108 of the backend server 104 in order to get access to his/her task managing account (as registered by the user). The user may then be able to see all tasks related to his/her phone number. Further, the user may also see an option in the task managing application to create new tasks. The user may use on the option to create new tasks in order to assign a task to another user.

Thereafter, the task managing application may ask the user to enter phone number of a user to whom the user wants to assign the task. The user may then either enter phone number manually or may use contact book of his/her communication device to find required phone number. In an embodiment, phone number may refer to a contact number that can be used by a user to establish a communication session with any other user over network 106.

After selecting required phone number, the user may enter details corresponding to the task that is to be accomplished by other user. In an embodiment, the user may enter text data to explain the task. In addition, the user may optionally use graphical, audio, visual data to explain the task. The task supervising system 108 may provide the user an option to upload files, which the user can send to the other user.

After providing sufficient details corresponding to the task that is to be accomplished by the other user, the user may have an option to add phone numbers of other users that may work as team with the other user in accomplishing same task. In an embodiment, the user may assign one task to more than one user. Further, it may be a case that the user may need to inform one or more persons regarding assignment of the task to the other user, in such case, the user may add phone number of those persons (to whom the user wants to notify) as a carbon copy (hereinafter may be referred to as “cc”). In an embodiment, the task supervising system 108 may provide the user an option to add phone numbers in a ‘cc’ field. Further, the task supervising system 108 may be configured to notify users (whose phone number is added in cc field), corresponding to progress made in related tasks and may also allow such users to view and manage the related tasks.

Moreover, the task supervising system 108 may provide an option to the user to assign a level of urgency, importance, priority, impact, or effort to the task. In an embodiment, any combination of such levels can be assigned to the task. The user may assign such levels in order to prioritize the task. Further, a creator of a task can mark the task as ‘closely watched’ and these tasks can be monitored separately under this category. In addition, the task supervising system 108 may provide an option to the user to assign a deadline for completion of the task. In case if a deadline is assigned to a task, then the task supervising system 108 may send reminders to a person (who is responsible to complete task before deadline) corresponding to time left for completing the task. Additionally, the task supervising system 108 may also send reminders to the creator and supervisor of the task.

Further, the task supervising system 108 may enable a user with an option to re-assign a task, which is already completed by some person, to same or different person. Moreover, the task supervising system 108 may also enable a user to create a task that will be automatically and repeatedly re-assigned to same or a different user after certain interval of time or immediately after completion of the task. For example, if a task is to fill a tank of water on daily basis, then a user need not to re-assign this task daily to some other user, and can simply select an option provided by the task supervising system 108 by which the task supervising system 108 will automatically re-assign the task daily to a designated person.

After creating the task, the user may assign certain attributes to the task. The attributes for a task may include, but are not restricted to, assigning importance level, assigning priority level, assigning urgency level, assigning impact level, assigning effort level, assigning deadline for completion of the task, and assigning other instructions, comments, or remarks for the task or attaching files to the task Thereafter, the task supervising system 108 may first analyze if communication device associated with assigned phone number has the task managing application or not. In case, if the communication device do not have the task managing application, then the task supervising system 108 may send an SMS to assigned phone number with necessary information corresponding to assigned task.

Otherwise, if the communication device has the task managing application installed in the communication device, then the task managing application may notify its user corresponding to newly assigned task. The user of the communication device may then use the task managing application in his/her communication device to view newly assigned task. In an embodiment, when a user accesses the task managing application in his/her communication device then the task managing application may first connect to the task supervising system 108 via the network 106. Thereafter, the communication device and the task supervising system 108 may synchronize related data to update any information in the communication device. Therefore, the user of the communication device may view (on his communication device via the task managing application) all the tasks that are related to him/her (along with attributes of the tasks).

Further, in an embodiment of the present invention, the task supervising system 108 may facilitate its user by providing an option to put certain tasks in a junk box. For example, if a task is assigned to a user, and phone number of creator of the task is not present in contact list (or phonebook) of the communication device, then the task supervising system 108 may directly move assigned task in the junk box. Therefore, the user of the communication device may be notified that a new task is assigned to him/her and details corresponding to the assigned task is present in the junk box of his/her task managing application. Additionally, the task supervising system 108 may facilitate its users by enabling the user to mark one or more phone numbers (that may or may not present in user's contact list) as a junk source. Thereafter, any task assigned from junk-marked phone numbers will be directly moved to the junk box.

Additionally, the task supervising system 108 may provide an option to its users to update status/progress of the task via the task managing application. Further, if a user updated status of his/her task, then the task supervising system 108 may inform all related users corresponding to the updated status of the task. In an exemplary embodiment, the task supervising system 108 may inform the creator and supervisor of the task on every change in the status of the task made by the owner of the task. For example, if user A assigned a task to user B and marked phone number of user C in cc field, then if user B accepts the task, user A and user C will be notified that the assigned task has been accepted by user B. Thereafter, if the user B updates that he/she is holding the task for one week, then accordingly user A and user C will be notified by the task supervising system 108 (via a message or an alert) that the user B has putted the task on hold for one week. Similarly, if the task is completed by the user B, then user A and user C will be notified that the task is completed by the user B. Further, the user A and user C may be able to view summary of the task (created by the task supervising system 108 or by user B).

Further, the task supervising system 108 may enable the users to whom a task is assigned to manage their tasks with several options. The several options may include, but is not limited to, marking status of a task as ‘closed’, ‘on-hold’, ‘started’ etc., adding remarks against the task, communicating with creator of the task, changing priority of the task, modifying date of the task, requesting creator of the task for cancellation, marking the task as closely watched, and marking the task as junk etc.

Similarly, the task supervising system 108 may also enable the users who have created a task to manage their tasks with several options. The several options may include, but is not limited to, marking status of a task as ‘closed’, ‘on-hold’, ‘started’ etc., adding remarks against task, changing priority of the task, communicating with users related to the task, modifying date of task, announcing a task as cancelled, sending reminders against a task, marking task as closely watched etc.

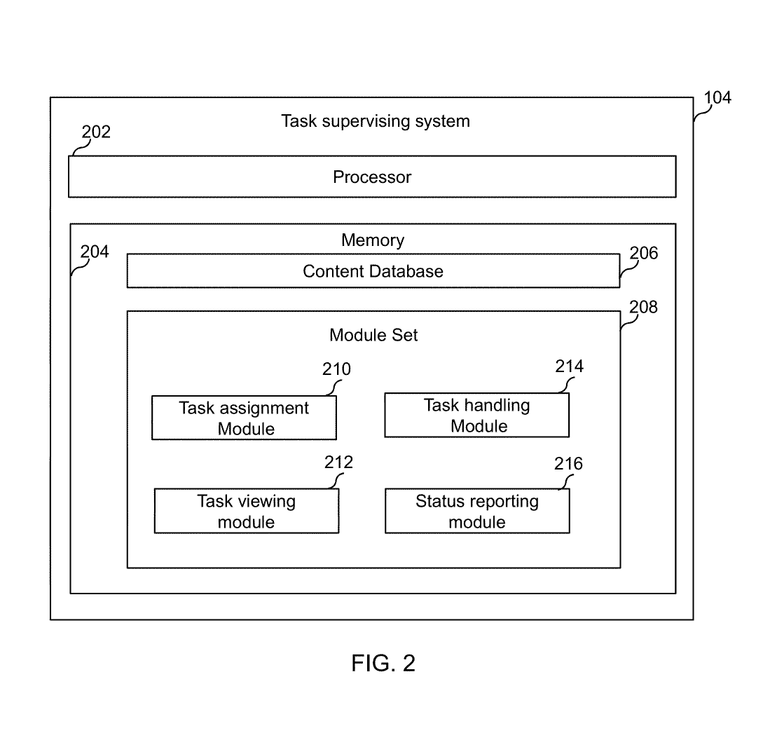

FIG. 2 illustrates a block diagram of a system, such as the task supervising system 108, for enabling registered users to manage their tasks by using a task managing application, in accordance with an embodiment of the present invention. The task supervising system 108 includes a processor 202 and a memory 204. The memory further includes a content database 206 and a module set 208. The content database may include, but is not limited to, registration details of its users, data corresponding to tasks, attributes of the tasks, communication corresponding to the tasks, information of notifications, action log of actions taken by any user on the task and general information related to tasks etc. Further, the module set 208 includes various modules having instructions executable by the processor 202. The various modules includes task assignment module 210, task viewing module 212, task handling module 214, and task reporting module 216.

The task assignment module 210 may include instructions executable by the processor 202 to enable a user (hereinafter, referred as ‘creator’) to create and assign a task to at least one other user (hereinafter, referred as ‘owner’). Further, the task assignment module 210 may enable the creator to first create a task by providing details corresponding to aim of the task, instructions related to task, information related to the task, guidelines related to the task etc. Thereafter, the task assignment module 210 may enable the creator to add attributes to the task. The attributes for the task may include, but are not restricted to, assigning importance level, assigning priority level, assigning urgency level, assigning impact level, assigning effort level, assigning deadline for completion of the task, and assigning other instructions, comments, or remarks for the task etc.

Further, the task assignment module 210 may enable the creator to select a phone number of the owner from contact list of his/her communication device to assign the task to the owner. In an embodiment, the creator may also type phone number of the owner if the owner does not have the saved in the contact list. Furthermore, the task can be assigned to a user as a supervisor of the task if the phone number is added as carbon copy for the task. Further, it is responsibility of owner to own assigned task and drive it to a closure. Furthermore, it is duty of the supervisor to supervise the task and keep a check on the progress of the task. Furthermore, it is responsibility of the owner of the task to keep the supervisor and the creator informed corresponding to status of the task.

In addition, the task assignment module 210 may include instructions executable by the processor 202 to check if communication device of the owner of the task has the task managing application (as defined earlier in the FIG. 1 of the invention) installed in it or not. In case, if the communication device of the owner of the task has the task managing application installed in it then the task assignment module 210 may send task details (corresponding to new task that is assigned to the owner) directly to the task managing application. The task managing application may then alert the owner for new task allocation. In other case, if the communication device of the owner does not possess the task managing application then the task assignment module 210 may send task details to the communication device of the owner via SMS.

Further, the task viewing module 212 may include instructions executable by the processor 202 to enable a user to view details related to his/her tasks. Further, the task viewing module 212 may enable a user to view all the tasks that are created by the user (for example, the creator), assigned to the user (for example, the owner), or supervised by the user. Furthermore, the task viewing module 212 may enable the user to select a task and view its attributes and other details. Moreover, the task viewing module 212 may enable the user to view the tasks that are present in junk box. Additionally, the task viewing module 212 enable the user to view reminders, comments, instructions, or messages received from supervisors or creators of the tasks that are owned by the user.

The task handling module 214 may include instructions executable by the processor 202 to enable a user to manage all those tasks that are created by the user (for example, the creator), assigned to the user (for example, the owner), or supervised by the user. The task handling module 214 may provide several options to the user to manage their tasks. The several options may include adding/changing status of the tasks and performing actions against the task. The status of the task may include, but is not limited to, marking status of a task as ‘assigned, ‘started’, ‘closed’, ‘closely watched’, ‘on-hold’, ‘in progress’, ‘half done’, ‘final mode’, etc. In addition, the user can add any custom message as stats of the task.

Further, the user may perform certain actions against the tasks, the certain actions may include, but are not restricted to, adding remarks against the task, communicating with users related to the task, changing attributes of the task, adding new attributes to task, adding a request for cancellation or cancelling of the task, marking the task as closely watched (such tasks will be of closely watched category for this user only), marking the task as junk, marking a phone number as a junk source of tasks, marking a phone number as a genuine source of tasks, sending alerts/reminders/messages to the users related to the task, viewing details corresponding to alerts/reminders/messages received from the users related to the task etc.

In an embodiment, a user can simply mark certain phone numbers as a source of junk tasks and the task handling module 214 may move all tasks received from the phone number into junk box. In addition, if a task is assigned by a phone number that is not present in the contact list of a user, then the task handling module 214 may automatically move such tasks in the junk box.

The status reporting module 216 may include instructions executable by the processor 202 to enable an owner of a task to update status of the task. Further, the status reporting module 216 may be configured to automatically share updated status information with the creator and supervisors of the task. For example, if user A is owner of a task, user B is creator of task, and user C and D are supervisors of the task, then if user A updates status of the task as ‘partially completed’ then the status reporting module 216 may update such information in accounts of users B, C, and D and the users may be notified that the user A has partially completed the task.

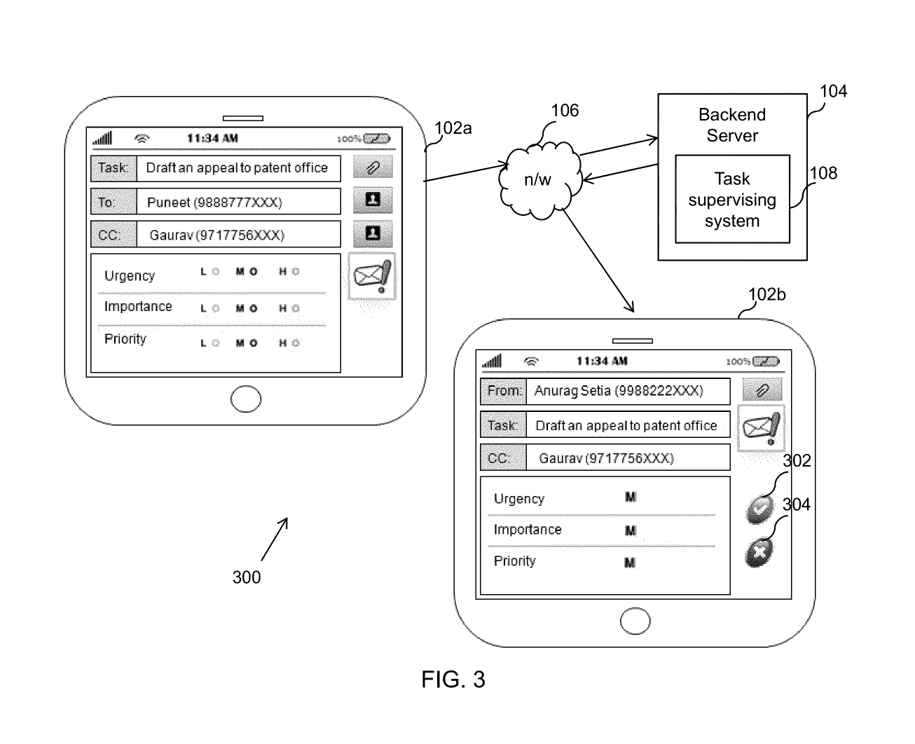

FIG. 3 illustrates another exemplary environment 300 where various embodiments of the present invention are implemented. As shown, the user device 102a is in communication with the backend server 104 via the network 106. Further, the backend server 104 is in communication with the user device 102b via the network 106. Thereby, user devices 102a and 102b are in communication with each other via the backend server 104. Furthermore, as shown in display screen of the user devices 102a and 102b, user of the user device 102a has assigned a task to user of the user device 102b.

Further, as apparent from “To” field displayed in the user device 102a, name of the user of the user device 102b is “Puneet”. Further, phone number of Puneet is also illustrated. Furthermore, as apparent from “From” field displayed in the user device 102b, name of the user of the user device 102a is “Anurag Setia”. Again further, as apparent from “cc” field displayed in the user device 102a, the user of the user device 102a has added “Gaurav” as cc contact for the task. Hereinafter, the user of the user device 102a will be referred to as “Anurag” and the user of the user device 102b will be referred to as “Puneet”.

As shown, Anurag has created a task of ‘drafting an appeal to patent office’ and assigned the task to Puneet. Moreover, Anurag has also informed Gaurav corresponding to assignment of the task to Puneet. In addition, Anurag has defined attributes to the task. The attributes illustrates that urgency, importance, and priority of the task is of ‘medium’ level. Apparently, creator of the task is Anurag, owner of the task is Puneet, and supervisor of the task is Gaurav. In addition to information illustrated in FIG. 3 of the present invention, Anurag may also have an option to set a deadline for Puneet to complete the task.

In an embodiment of the present invention, after creation of the task at the device 102a, task related data will be transferred to the backend server 104 (or task supervising system 108). The backend server 104 may then save the task related data in its content database 206. Thereafter, the task supervising system 108 may update received data in account of the user device 102b. Further, whenever the user device 102b will synchronize data from the backend server 104, the task managing application installed in the user device 102 may notice that a new task is assigned. Thereafter, the task managing application may alert the user of the device 102b via graphical as well as audio alerts. The user of the user device 102b may then view the task related data corresponding to the new task and may decide whether to accept or reject the task. As shown, in user device 102b, two buttons 302 and 304 are provided for accepting or rejecting the task. Button 302 may allow the user of the user device 102b to accept the task and button 304 may allow the user to reject the task. In all cases, whether owner (Puneet) of the task accepts or rejects the task, creator (Anurag) and supervisor (Gaurav) of the task will be notified by the task supervising system 108 corresponding to the rejection or acceptance of the task by the owner (Puneet).

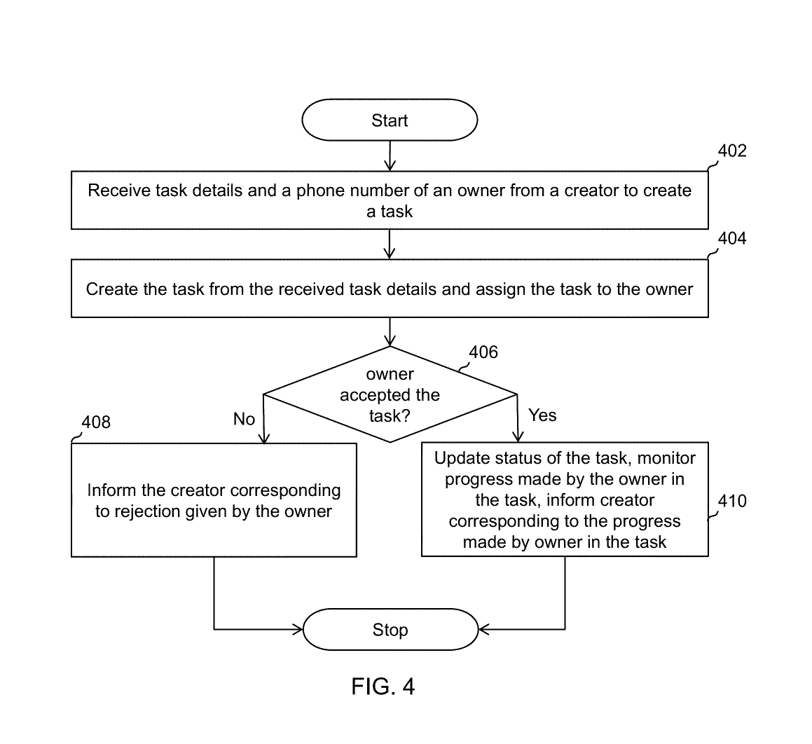

FIG. 4 illustrates a flow diagram of a method for creating, assigning and monitoring a task, in accordance with an embodiment of the present invention. At step 402, the task supervising system 108 (as illustrated in the FIG. 1 of the present invention) may receive a phone number of a user (hereinafter, referred as ‘owner’) from another user (hereinafter, referred as ‘creator’). The ‘creator’ may refer to the user who has created a task. Further, the ‘owner’ may refer to another user who has been assigned the task by the creator. In addition, the creator may also send a phone number of a supervisor of the task to the task supervising system 108. Moreover, the task supervising system 108 may receive details and attributes corresponding to a task from the creator. The task supervising system 108 may then store the details and attributes into its database (such as content database 206, as shown in FIG. 2 of the present invention).

Further, at step 404, the task supervising system 108 may create a task from the details and attributes received from the creator. Thereafter, the task supervising system 108 may add owner as an executioner of the task (as the creator assigned the task to the owner for executing the task) in its content database 206. Further, the task supervising system 108 may notify the creator corresponding to the successful assignment of the task to the owner. Simultaneously, the task supervising system 108 may notify the owner corresponding to new task that is assigned to him/her by the creator. Thereafter, the task supervising system 108 may wait until the owner responds to new task assignment.

At step 406, task supervising system 108 may determine if the owner accepted or rejected the task. In case, if the owner rejected the task (i.e. rejected to work on the task), then the task supervising system 108 may (at step 408) inform the creator corresponding to rejection given by the owner for accepting the task. In case, if the owner accepted the task given by the creator, then at step 410, the task supervising system 108 may first inform the creator corresponding to acceptance of the task by the owner.

Thereafter, the task supervising system 108 may keep a check on progress made by the owner in the task. In an embodiment, the task supervising system 108 may allow the owner to update status of the task at his device, and the task supervising system 108 may convey the status updated by the owner to the creator. Similarly, the task supervising system 108 may keep on conveying the status of the task to the creator until the task is closed by the owner or cancelled by the creator.

In an embodiment of the present invention, the task may include multiple (or a plurality of) stages. The task supervising system 108 may send or convey the status of the task to the creator, at completion of each stage of the task. In another embodiment of the present invention, the task supervising system 108 may send the status of the task to the creator, at predetermined intervals e.g., daily, each Monday, etc. until the completion of the task. In yet another embodiment, the task supervising system 108 may inform the creator and supervisor of the task on every change in the status of the task made by the owner of the task. Further, the task supervising system 108 may also send reminder to the owner/creator about progress of the task, in case the progress of the task is not on schedule. Hence, the creator/supervisor will be updated about the progress of the task automatically.

Furthermore, it may be appreciated by the person skilled in the art that the present invention is not limited to the above-mentioned embodiments. Further, various other embodiments may also be implemented through the features provided by the system. Also, the usage of terminology such as ‘task’, ‘attributes’, and ‘phone number’ may not be considered as restrictive aspect of the present invention as such terminologies are used just for the purpose of better explanation.

Advantageously, the present invention provides a method and a system to create, assign, track, and manage a task by using phone numbers of the users. A user can assign a task to a phone number present in his/her contact list and the owner of the phone number will be notified corresponding to the assigned task. Further, the present invention supports use of a task managing application that can be installed in a communication device in order to connect to a backend server, which keeps records of all tasks and related information. This enables users to track history of tasks and may have access to the tasks completed in past. Furthermore, the present invention provides a seamless means to the users to assign a task to a user and monitor status of the task in a hassle free manner. In addition, the present invention supports carbon copying one or more persons, so that creator of a task may assign one or more supervisors to the task. Thereby, the present invention provides a user friendly platform for the users to manage their personal or official tasks in a time efficient and convenient manner.

It may be appreciated by a person skilled in the art that the present invention is not limited to the advantages as mentioned here above. Further many other advantages may be understood in light of the description given above without departing from the scope of the present invention. Embodiments of the present invention are described above with reference to block diagrams and schematic illustrations of methods and systems according to embodiments of the invention. It will be understood that each block of the diagrams and combinations of blocks in the diagrams can be implemented by computer program instructions. These computer program instructions may be loaded onto one or more general purpose computers, special purpose computers, or other programmable data processing translator to produce machines, such that the instructions that execute on the computers or other programmable data processing translator create means for implementing the functions specified in the block or blocks. Such computer program instructions may also be stored in a computer-readable memory that can direct a computer or other programmable data processing apparatus to function in a particular manner, such that the instructions stored in the computer-readable memory produce an article of manufacture including instruction means that implement the function specified in the block or blocks.

While the present invention has been described in connection with what is presently considered to be the most practical and various embodiments, it is to be understood that the invention is not to be limited to the disclosed embodiments, but on the contrary, is intended to cover various modifications and equivalent arrangements included within the spirit and scope of the appended claims. The present invention has been described in the general context of computing devices, phone and computer-executable instructions, such as program modules, being executed by a computer. Generally, program modules include routines, programs, characters, components, data structures, etc., that perform particular tasks or implement particular abstract data types. A person skilled in the art will appreciate that the invention may be practiced with other computer system configurations, including hand-held devices, multiprocessor systems, microprocessor-based or programmable consumer electronics, network PCs, minicomputers, mainframe computers, and the like. Further, the invention may also be practiced in distributed computing worlds where tasks are performed by remote processing devices that are linked through a communications network. In a distributed computing world, program modules may be located in both local and remote memory storage devices.

This written description uses examples to disclose the invention, including the best mode, and also to enable any person skilled in the art to practice the invention, including making and using any devices or systems and performing any incorporated methods. The patentable scope the invention is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A task supervising system, comprising:
a processor; and
a memory coupled to the processor, the memory comprising;
a task assignment module configured to receive task details from a creator for creating and assigning a task to an owner by using phone number of the owner's communication device; and
a task handling module configured to enable the creator to manage the task; and
a status reporting module configured to inform the creator corresponding to progress made by the owner in the task.

2. The task supervising system of claim 1, wherein the task assignment module is configured to enable the creator to assign the task to the owner by using a phone number of the owner, selected from a contact list that is stored in communication device of the creator.

3. The task supervising system of claim 2, wherein the phone number is typed by the creator.

4. The task supervising system of claim 1, wherein the task assignment module is further configured to let the creator assign one or more supervisors for the task.

5. The task supervising system of claim 1, wherein the task assignment module is further configured to let the creator to assign one or more attributes to the task.

6. The task supervising system of claim 1, wherein the task assignment module is further configured to let the creator to set a deadline for completion of the task.

7. The task supervising system of claim 1, wherein the status reporting module is configured to send status of progress of the task to the creator on change of state of the task.

8. The task supervising system of claim 1, wherein the status reporting module is configured to inform the creator if progress of the task is not on schedule.

9. The task supervising system of claim 1, further comprising a task viewing module configured to let the owner view details of tasks that are related to the owner.

10. A computer-implemented method of creating, assigning, and tracking a task, the method comprising:
receiving details of a task, and a phone number of a communication device of at least one owner from a creator;
assigning the task to the owner by sending details of the task to the communication device of the owner;
enabling the owner to update status corresponding to progress in the task; and
notifying the creator corresponding to updated status of the task.

11. The computer-implemented method of claim 10, further comprising enabling the creator to change the attributes of the task.

12. The computer-implemented method of claim 10, further comprising enabling the creator to send reminders to the owner for completing the task.

13. The computer-implemented method of claim 10, wherein the attributes comprises priority information for the task.

14. The computer-implemented method of claim 10, wherein the creator and the owner are enabled to add remarks to the task.

15. The computer-implemented method of claim 10, where in the notifying comprises notifying the creator about progress of the task on every change of state of the task.

16. The computer-implemented method of claim 10, where in the notifying comprises notifying the creator or owner as a reminder to complete the task.

17. A computer readable medium having computer executable instructions which when executed by a processor, causes the processor to perform a method comprising:
receiving details of a task, and a phone number of a communication device of at least one owner from a creator;
assigning the task to the owner by sending details of the task to the communication device of the owner;
enabling the owner to update status corresponding to progress in the task; and
notifying the creator corresponding to updated status of the task.

18. The computer readable medium of claim 17, wherein the received task is categorized as junk or non important task if the phone number from which task is assigned is not available in a contact list of the communication device of the creator.

19. The computer readable medium of claim 17, wherein the received task is categorized as junk or non important task if the phone number in a contact list of the communication device of the creator is marked as junk or non important task.

20. The computer readable medium of claim 17, wherein the received task is categorized as important task if the phone number in a contact list of the communication device of the creator is marked as important task.
